(19) United States
(12) Patent Application Publication
(10) Pub. No.: US 2012/0060298 A1
(43) Pub. Date: Mar. 15, 2012

(54) FISH HOOK CLEANING TOOL

(76) Inventor: James Campbell, Anacortes, WA (US)

(21) Appl. No.: 12/878,033

(22) Filed: Sep. 9, 2010

(51) Int. Cl. A01K 97/00

(52) U.S. Cl. 7/106

(57) ABSTRACT

A fish hook cleaning tool comprising a tapered body including a blunt end and a pointed end, a hole within the blunt end, a tip along the pointed end, and a textured material within the hole and on the pointed end wherein the textured material enables a user to clean and file a fish hook to remove a particulate from the fish hook and to sharpen the fish hook between uses. The tip of the pointed end is sharp enough to fit within an eyelet of the fish hook to clean the particulate within the eyelet to more easily thread a fishing line.

### BACKGROUND OF THE INVENTION

1. Field of the Invention

The present invention relates to a combination tool which sharpens a fish hook and removes the debris accumulated on the hook and eyelet while fishing.

2. Description of Related Art

Fishing is a fun recreational and sporting activity enjoyed by many people. Fishermen have their preferred methods to fish, but a few concepts are common to all; utilizing a hook and a line to snare a fish. Even thought the basic concept is simple, the techniques used have transformed fishing into what some consider an art form, with a style and preferred equipment for everyone.

A common problem, shared by all fishermen, relates to debris that may collect on the hook. Many people not only catch fish, but also various particles and debris that may be floating in the water. After a while, the hooks may have fish guts, scales, seaweed, skin, dirt, blood or all of the above stuck and dried onto the hook and eyelet. All of the debris may interfere with the equipment functioning properly, thus resulting in less fish caught. Sometime there may be so many particles on the hook that the fisherman simply throws the hook away to be replaced with a new, clean hook. Some fishermen carry brushes or files in their tackle boxes to clean and sharpen the fish hooks. These tools may help to remove some of the debris but they do not remove it all. Many times junk is left inside the barb and in the eyelet.

It would be beneficial in the art to have a tool which cleans out the fish hooks thoroughly and efficiently. It would also be desirable to have a device that not only cleans but also sharpens the hooks.

### SUMMARY OF THE INVENTION

The primary purpose of the present invention is to provide a tool for cleaning fish hooks, lures and bobbers. The fish hook cleaning tool comprises a tapered body including a blunt end and a pointed end, a hole within the blunt end, a tip along the pointed end, and a textured material within the hole and on the pointed end wherein the textured material enables a user to clean and file a fish hook to remove a particulate from the fish hook and to sharpen the fish hook between uses. The tip is sharp enough to fit into an eyelet of the fish hook to remove the particulate within the eyelet and enable the fisherman to more easily thread a fishing line.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 is a perspective view of a fish hook cleaning tool in an exemplary embodiment of the present invention.

### DETAILED DESCRIPTION

The present invention relates to a hand tool for cleaning fishing hooks, lures and bobbers. The fish hook cleaning tool includes a set of textured surfaces to serve as a file to sharpen the fish hooks between uses. At an end, the fish hook cleaning tool has a pointed tip to get into an eyelet of a fish hook or lure to remove the grime dried after usage. The clean eyelet allows a fisherman to easily thread and remove a fishing line, without risking snags or tears with a dirty eyelet. If the line snags or tears the fisherman runs the risk of losing the lure, ultimately resulting in wasted expenses for replacing lost equipment.

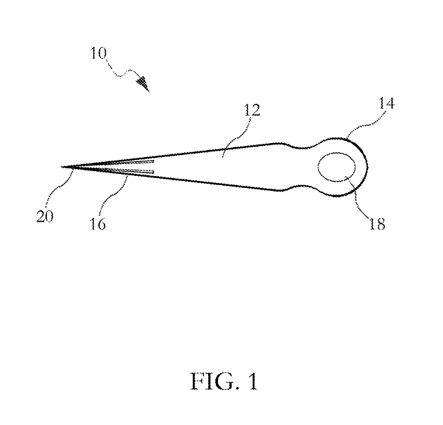

Turning now descriptively to the drawing, referring to FIG. 1, a perspective view of a fish hook cleaning tool (10) according to the present invention is shown. The fish hook cleaning tool (10) may have a tapered body (12), a blunt end (14) and a pointed end (16). The tapered body (12) may serve as a handle or gripping portion of the fish hook cleaning tool (10), and may be made from a hard plastic or metal. The tapered body (12) may have a round tubular shape, or it may be flat for a more compact design. The blunt end (14) is at an end of the tapered body (12), and may have a hole (18). The pointed end (16) is at an opposite end of the tapered body (12) from the blunt end (14). The pointed end (14) may be a continuation of the tapered body (12) or a separate piece of hard plastic or metal attached to the tapered body (12). Furthermore, the pointed end (14) includes a tip (20) sharpened to a point. The tip (20) may be used to clean an eyelet of a fish hook or a lure from any fish remains or particulate collected from the water.

On an inner surface of the hole (18) may be a grit material or textured surface which functions like sandpaper or a file. The pointed end (14) may also be covered with the textured surface. The textured surface may be used as a cleaning mechanism for the fishing hook, the eye or a fishing line, or as a file to sharpen the hook between uses. If the fish hook builds up residue while fishing, a user may thread the hook into the hole (18) and rub it against the textured surface to remove any debris. While threaded, the user may safely clean and sharpen the fish hook without poking their fingers because the hole (18) enables the fish hook cleaning tool (10) to engage the hook while allowing the user to keep their fingers away from the barb. The hole (18) may have a circular, square, rectangular or various other geometric shapes. The user may thread the hook and line through the hole (18), to facilitate removing any debris on the fishing line as well.

Similarly, the textured surface on the pointed end may assist the user when using the tip (20) to clear the residue within the eyelet or against the barb. The tip (20) may allow the user to get into the small crevices, while the textured surface helps to remove the grime dried on the hook. The textured surface on the pointed end (16) may also function as a file to maintain the quality of the fish hook between uses. With a clean eyelet, the fisherman may easily thread and remove the fishing line without any snags or tears. By enabling the user to clean and sharpen their hooks, lures and bobbers, the equipment is reusable and money is saved by not having to replace damaged or lost parts.

The fish hook cleaning tool (10) may also be used to clean and make holes on spin bobbers, small fishing floats and painted jig heads. Bobbers, floats and jig heads are massed produced and usually do not have holes, so a user must make a hole in the bobber, float or jig head prior to use thereof. The fish hook cleaning tool (10) according to the present invention helps to produce a smooth round hole so that the bobber, float or jig head spins freely, provides good action and diminishes the likelihood of line tangles.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What we claim is:

1. A fish hook cleaning tool comprising:
a tapered body including a blunt end and a pointed end;
a hole within the blunt end;
a tip along the pointed end; and
a textured material within the hole and on the pointed end wherein the textured material enables a user to clean and file a fish hook to remove a particulate from the fish hook and to sharpen the fish hook between uses.

2. The fish hook cleaning tool of claim 1, wherein the tip is sharp enough to fit into an eyelet of the fish hook to clean any particulate within the eyelet to more easily thread a fishing line.

3. The fish hook cleaning tool of claim 1, wherein the tapered body has a tubular shape.

4. The fish hook cleaning tool of claim 1, wherein the tapered body has a flat shape.

5. The fish hook cleaning tool of claim 1, wherein the hole loops around the fish hook to clean a fishing line.
